(19) United States
(12) Patent Application Publication
(10) Pub. No.: US 2007/0282992 A1
(43) Pub. Date: Dec. 6, 2007

(54) Method and system for service management in a zone environment

(75) Inventor: Lei Liu, San Jose, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/444,919

(22) Filed: Jun. 1, 2006

(51) Int. Cl. G01C 21/36; G06F 15/173

(52) U.S. Cl. 709/223

(57) ABSTRACT

A method for managing a service executing in a zone environment involves receiving a service management request, identifying a collection of requirements required by the service management request, triggering a data collector to collect zone-specific performance attributes from a plurality of zones in the zone environment, identifying at least one zone in the plurality of zones that has zone-specific performance attributes conforming to the collection of requirements, and provisioning the service on the at least one zone based on the service management request.

### BACKGROUND

Large organizations typically operate one or more data centers to distribute information both within and outside the organization. The data center typically includes multiple services for serving requests associated with the organization. A service is a software or infrastructure component that provides seamless access to a variety of data center resources (e.g., computation resources, data resources, etc.). For example, a computer user may access a web service at the data center through a web page to request the average rainfall in a certain location. As part of responding to the request, the web server may query a database server. Next, the database server sends the web server the response to the query, which forwards the answer to the computer user.

Typically, users may request information from the data center using a variety of devices. For example, one user may use a cell phone, while another user accesses the data center using a personal computer. Accordingly, the data center must be able to manage the multiple types of transport protocols from the devices.

Further, access to the data center may be performed from a variety of user services executing on the devices. For example, a user may request information using a web browser, a word processor, or any similar services. Thus, the format of the request and the format of the results vary depending on the service of the user.

In order to ensure that the services are executing properly, the services are managed. In the typical configuration, managing the service is performed by a service manager that controls and manages a single service. Specifically, the service manager may directly control the provisioning of the service on particular hosts and directly monitor the service to ensure that the service is performing properly.

### SUMMARY

In general, in one aspect, the invention relates to a method for managing a service executing in a zone environment. The method comprises receiving a service management request, identifying a collection of requirements required by the service management request, triggering a data collector to collect zone-specific performance attributes from a plurality of zones in the zone environment, identifying at least one zone in the plurality of zones that has zone-specific performance attributes conforming to the collection of requirements, and provisioning the service on the at least one zone based on the service management request.

In general, in one aspect, the invention relates to a system for managing a service executing in a zone environment. The system comprises a data collector configured to collect zone-specific performance attributes from a plurality of zones with the zone environment, and a performance manager configured to receive a service management request, identify a collection of requirements required by the service management request, identify at least one zone in the plurality of zones that has zone-specific performance attributes conforming to the collection of requirements, and provision the service on the at least one zone based on the service management request.

In general, in one aspect, the invention relates to a computer usable medium. The computer usable medium comprises computer readable program code embodied therein for causing a computer system to receive a service management request, identify a collection of requirements required by the service management request, trigger a data collector to collect zone-specific performance attributes from a plurality of zones, identify at least one zone in the plurality of zones that has zone-specific performance attributes conforming to the collection of requirements, and provision a service on the at least one zone based on the service management request.

Other aspects of the invention will be apparent from the following description and the appended claims.

### BRIEF DESCRIPTION OF DRAWINGS

FIG. 1 shows a schematic diagram of a zone environment with service management in accordance with one or more embodiments of the invention.

FIG. 2 shows a schematic diagram of a system for managing a service in a zone environment in accordance with one or more embodiments of the invention.

FIG. 3 shows a flowchart of a method for collecting performance data in accordance with one or more embodiments of the invention.

FIG. 4 shows a flowchart of a method for processing a service management request in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for managing a service in a zone environment. Specifically, embodiments of the invention use data collectors embedded in the zone environment to identify and maintain performance information for both the zones and the services found within the zones. More specifically, embodiments of the invention assemble the performance information and transfer the performance information to the service manager that is responsible for managing the service. Thus, a service manager provides virtualized service management with zone and host agnostic (e.g., platforms running the SPARC (Scalable Processor Architecture) processors, UltraSparc T1 processors and any sort of standard processors (e.g., 8-bit, 16-bit, 32-bit, 64-bit,processors, etc.) service, level instrumentation and management.

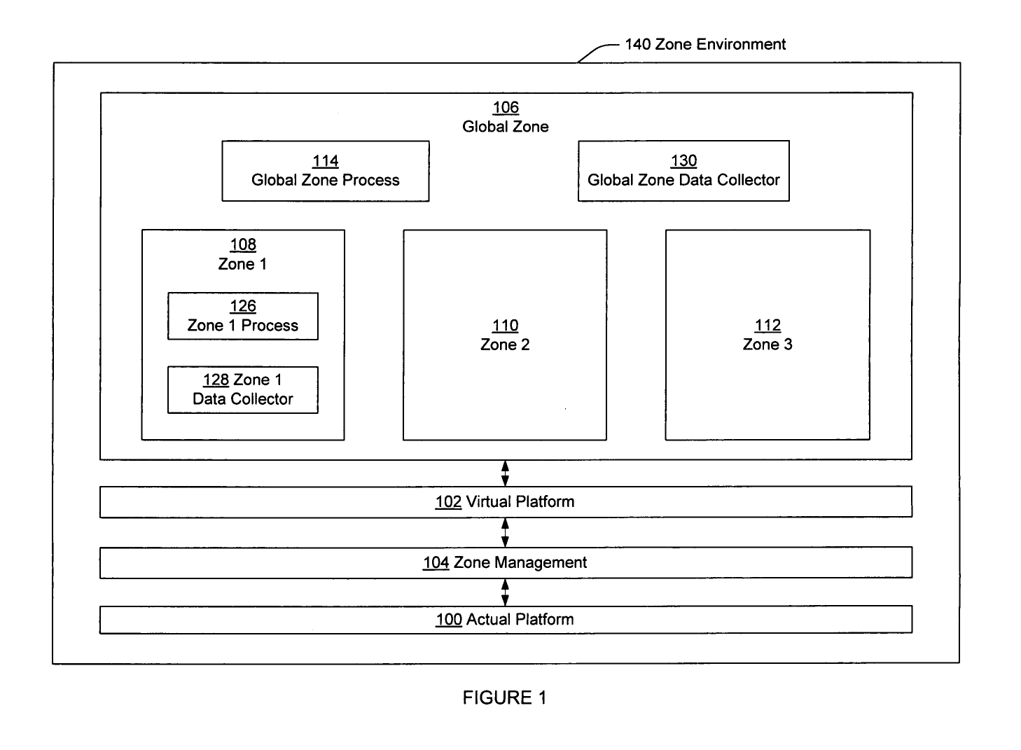

FIG. 1 shows a schematic diagram of a zone environment (140) in accordance with one or more embodiments of the invention. The zone environment (140) includes an actual platform (100). The actual platform (100) may include one or more of the following components: key physical resources (e.g., processors, memory, file systems) and physical resources (e.g., network interfaces, network devices, interfaces to data repositories, etc.) of the system, core operating system services, remote administering monitoring services, platform administrative services, etc. Further, the actual platform (100) may correspond to a single host (i.e., computer system) or span multiple hosts. The actual platform (100) interfaces with the virtual platform (102), via a zone management layer (104). The truly distributed zone management layer (104) typically includes functionality to administrate one or more zones (e.g., a global zone (106), zone 1 (108), zone 2 (110), zone 3 (112), etc.) within a physical host or through multiple hosts.

The virtual platform (102) typically includes a set of services and resources that allow full functionality of the zone architecture. For example, the virtual platform (102) may include network interfaces, devices, administration utilities, etc. The virtual platform (102) may interface with one or more zones (e.g., a global zone (106), zone 1 (108), zone 2 (110), zone 3 (112)).

In one or more embodiments of the invention, each non-global zone (e.g., zone 1 (108), zone 2 (110), zone 3 (112)) provides an isolated environment for running services. Each service may have one or more processes. Processes (e.g., zone 1 process (126)) running in a given zone are prevented from monitoring or interfering with other activities in the system. Access to other processes, network interfaces, file systems, devices, and inter-process communication facilities is restricted to prevent interaction between processes in different zones. The privileges available within a zone are restricted to prevent operations with system-wide impact.

In addition to processes, each non-global zone (e.g., zone 1 (108), zone 2 (110), zone 3 (112)) may also have a data collector (e.g., zone 1 data collector (128)). A data collector (e.g., zone 1 data collector (128)) corresponds to any type of functional unit that includes functionality to collect service-specific performance data and/or zone-specific performance data. A data collector deployed within a non global zone is responsible for either the service or user land's specific performance data collection. Since zones are sharing a single instance of a kernel resource, platform specific instrumentations are left out of the global zone collector of a specific host. The specific host provides the virtual execution environment for the zone. Service-specific performance data may include the response time (i.e., length of time between when a request is received and the request is processed), transactions per second (i.e., the number of transactions processed every second), and throughput (i.e., number of requests that may be processed in a given period of time) for the service executing in the corresponding non-global zone (e.g., zone 1 (108), zone 2 (110), zone 3 (112)). Zone-specific performance data may include processor usage, memory usage, disk usage, and/or network throughput. Further, zone-specific performance data may include the amount or number of available resources for a particular non-global zone (e.g., zone 1 (108), zone 2 (110), zone 3 (112)).

In one embodiment of the invention, each zone (e.g., zone 1 (108), zone 2 (110), zone 3 (112)) may be identified by an alphanumeric name and a numeric ID. When crossing different hosts, each zone (e.g., zone 1 (108), zone 2 (110), zone 3 (112)) may be uniquely identified by a hashed identifier. For example, a typical hashed identifier may be hashed using 126 bit SHA1 (a common Secure Hash Algorithm) in order to allow topology agnostic virtualization identification.

The zones (zone 1 (108), zone 2 (110), zone 3 (112)) are typically configured and administered using the utilities provided by the zone management (104) layer. These utilities allow an administrator to specify the configuration details of a zone, install file system contents (including software packages) into the zone, manage the runtime state of the zone, etc. In addition, a pseudo-terminal utility may allow an administrator to run commands within an active zone, without logging into the zone through a network-based login server.

The previously mentioned zones (zone 1 (108), zone 2 (110), zone 3 (112)) are included within a global zone (106). The global zone (106) always exists, and acts as the “default” zone in which all processes run if no zones have been created. Further, in one or more embodiments of the invention, the global zone (106) is the general operating environment (OS) that is created when the OS is booted and executed, and serves as the default zone in which processes may be executed if no non-global zones (e.g., zone 1 (108), zone 2 (110), zone 3 (112)) are created/present. In the global zone (106), administrators and/or processes having the proper rights and privileges may perform generally any task and access any device/resource that is available on the computer system on which the OS is run. Thus, processes running in the global zone (106) typically have the same set of privileges available on a system running without zones (e.g., privileges to load kernel modules, access physical devices, etc.). Further, an administrator logged into the global zone (106) may monitor and control the system as a whole (including the physical devices and network interface that are hidden from the other non-global zones).

In one or more embodiments of the invention, a global zone data collector (130) may include functionality to collect zone-specific performance attributes. Thus, the zone-specific performance attributes may also include percentage of processor, memory, and/or network usage dedicated to a particular non-global zone (e.g., zone 1 (108), zone 2 (110), zone 3 (112)). Specifically, because the global zone (106) has a global view of all zones on the host, the global zone data collector (130) is able to identify the percentage of resource usage dedicated to each non-global zone (e.g., zone 1 (108), zone 2 (110), zone 3 (112)).

In one or more embodiments of the invention, the aforementioned data collectors (e.g., zone 1 data collector (128), global zone data collector (130)) may correspond to virtually any type of probe (e.g., a Dtrace probe, developed by Sun Microsystems™, Inc. (located in Santa Clara, Calif.)), an embedded application management technology (e.g., remote Java™ Management Extensions, developed by Sun Microsystems™, Inc.), system calls, etc.

The zone architecture shown in FIG. 1 allows the physical system to be separated into isolated individual portions. Having non-global zones that are isolated from each other may be desirable in many applications. For example, if a single computer system running a single instance of an OS is to be used to host applications for different competitors (e.g., competing websites), then it would be desirable to isolate the data and processes of one competitor from the data and processes of another competitor. That way, it can be ensured that information is not leaked between the competitors. Partitioning the OS into non-global zones and hosting the applications of the competitors in separate non-global zones is one possible way of achieving this isolation.

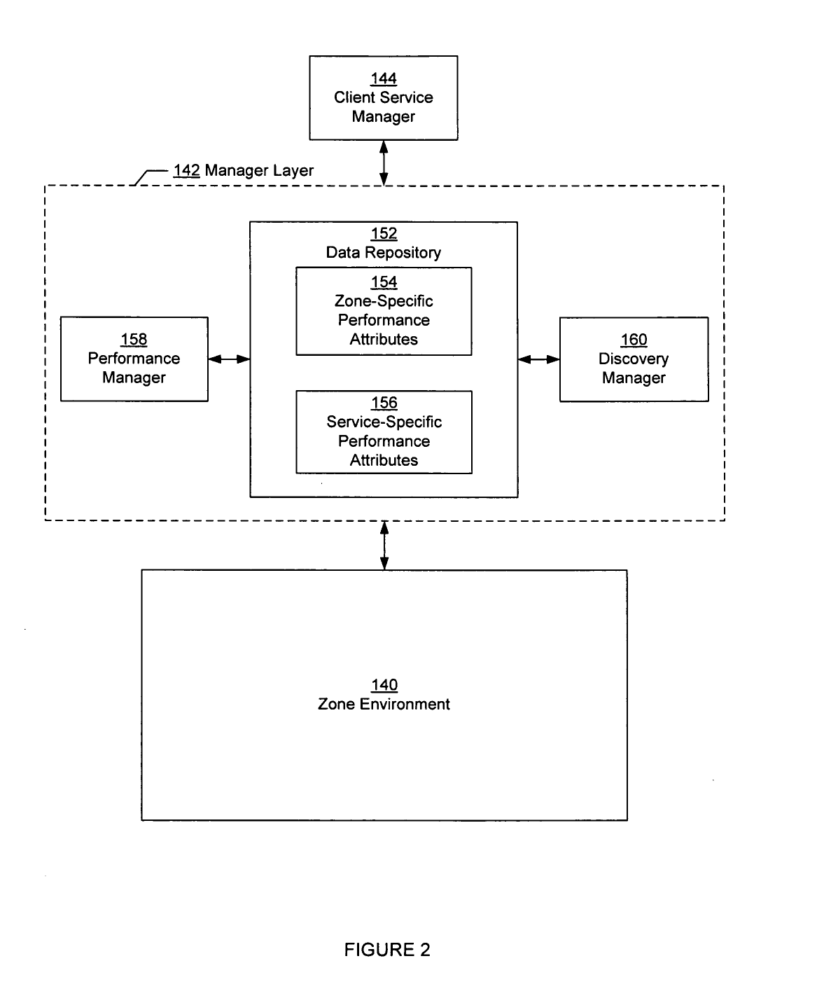

FIG. 2 shows a schematic diagram of a system for managing a service executing in a zone environment (140) in accordance with one or more embodiments of the invention. As shown in FIG. 2, the system includes the zone environment (140) (described above), a manager layer (142), and a client service manager (144). The manager layer (142) and the client service manager (144) are described below.

The manager layer (142) corresponds to an abstraction layer for the zone environment (140). Specifically, the manager layer (142) includes functionality to abstract the data collection and hardware knowledge from the client service manager (144). Furthermore, the manager layer (142) provides distributed service management and is adaptive to virtual environments across physical hosts. The manager layer (142) is a middleware utility for lower layer abstraction and higher level interoperability. In addition, the manager layer (142) includes a data repository (152), a performance manager (158), and discovery manager (160) in accordance with one or more embodiments of the invention.

The data repository (160) provides distributed indexing though virtual environments across physical hosts and corresponds to any type of storage unit, such as a file system, hierarchical database, relational database, spreadsheet, etc. for performance information. Specifically, stored within the data repository are zone-specific performance attributes (154) and service-specific performance attributes (156). The zone-specific performance attributes (154) and the service-specific performance attributes correspond to the attributes that are collected by the data collectors as described above and shown in FIG. 1. Further, in one or more embodiments of the invention, the zone-specific performance attributes (154) are sub-divided so as to correspond to the different zones. Accordingly, by accessing the zone-specific performance attributes, a user or program may identify which zone has particular desirable attributes available.

Similarly, the service-specific performance attributes may be subdivided by the different services and the different zones. Thus, by accessing the service-specific performance attributes, a user or program is able to identify how a particular service is operating on particular zones in the zone environment (140).

A performance manager (158) is connected to the data repository (152). A performance manager (158) corresponds to a logical component that includes functionality to receive and process service management requests, populate and query the data repository (152), and trigger data collection by the data collectors.

Similarly, a discovery manager (160) corresponds to a logical component that includes functionality to trigger data collection to discover new zones, retrieve zone-specific performance attributes, and populate the data repository with the retrieved performance information.

Continuing with FIG. 2, in one or more embodiments of the invention, a client service manager (144) is connected using UDP (User Datagram Protocol)-based lightweight transport protocol (not shown) in the manager layer (142). The client service manager (144) corresponds to any type of user or application that manages services. Specifically, the client service manager (144) includes functionality to create and send service management requests. In one or more embodiments of the invention, the client service manager (144) corresponds to a third party component that accesses the manager layer (142) through a user interface (not shown) of the manager layer.

The client service manager (144) is typically unaware of how the service is operating in the zone environment (140). Specifically, in one or more embodiments of the invention, the client service manager (140) does not know which zone(s) the service is operating on in the zone environment. The client service manager (144) may only have information of the performance of the service through the collected performance information from a performance manager (158).

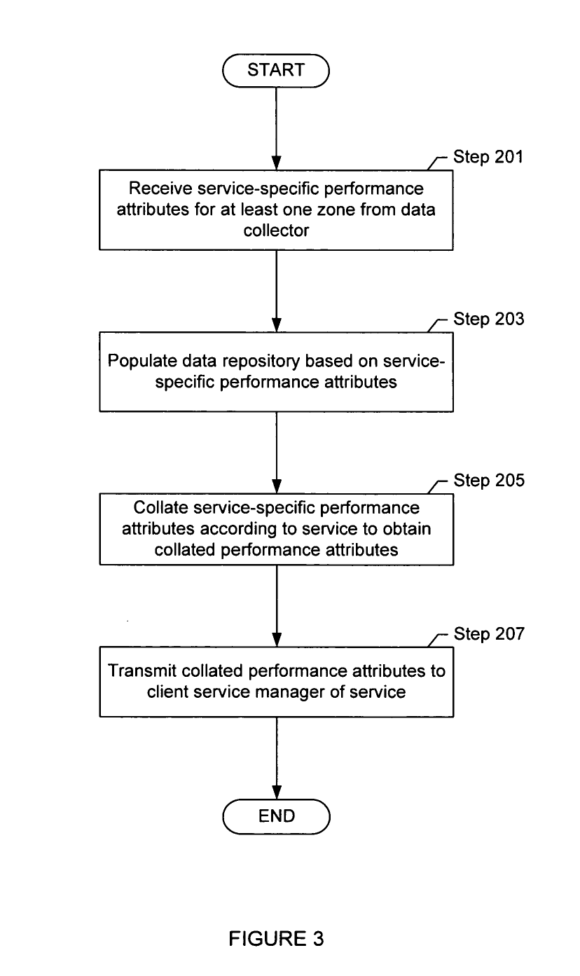

FIG. 3 shows a flowchart of a method for collecting performance data for managing a service executing in a zone environment in accordance with one or more embodiments of the invention. Initially, service-specific performance attributes for at least one zone is received from the data collector (Step 201). Specifically, at this stage, a data collector collects performance specific attributes for one or more services executing in the zone of the data collector. In order to collect the service-specific performance attributes, the data collector may be scheduled to periodically obtain service-specific performance attributes or the collection of the service-specific performance attributes may be triggered by an event. Further, in one or more embodiments of the invention, if the collection of service-specific performance attributes is periodic, then the collection of service-specific performance attributes may only be performed when the data collectors are enabled. Specifically, in order to not degrade performance by collecting data, the data collectors are configurable in relation to the period for which data is collected and whether the data collector is enabled or disabled.

Continuing with FIG. 3, after receiving service-specific performance attributes, the data repository is populated based on the service-specific performance attributes (Step 203). In one or more embodiments of the invention, the data repository is populated according to the service and the zone. Specifically, service-specific performance attributes may be subdivided by how instances of the service are executing in particular zones. Populating the data repository may be performed using any number of techniques well known in the art.

Once the data repository is populated, then the service-specific performance attributes are collated according to the service to obtain collated performance attributes (Step 205). At this stage, the information about particular zones may be removed. Further, a statistical analysis may be performed on the service-specific performance attributes in order to identify how the service is executing, on average, across all zones.

Next, the collated performance attributes are transmitted to the client service manager of the corresponding service (Step 207). By transmitting collated service-specific performance attributes, a simple user interface may be used to review the service-specific performance attributes. Specifically, rather than requiring the client service manager to interpret a variety of performance information, the client service manager can view how the service is operating as a whole and whether the service is meeting any associated service level agreements.

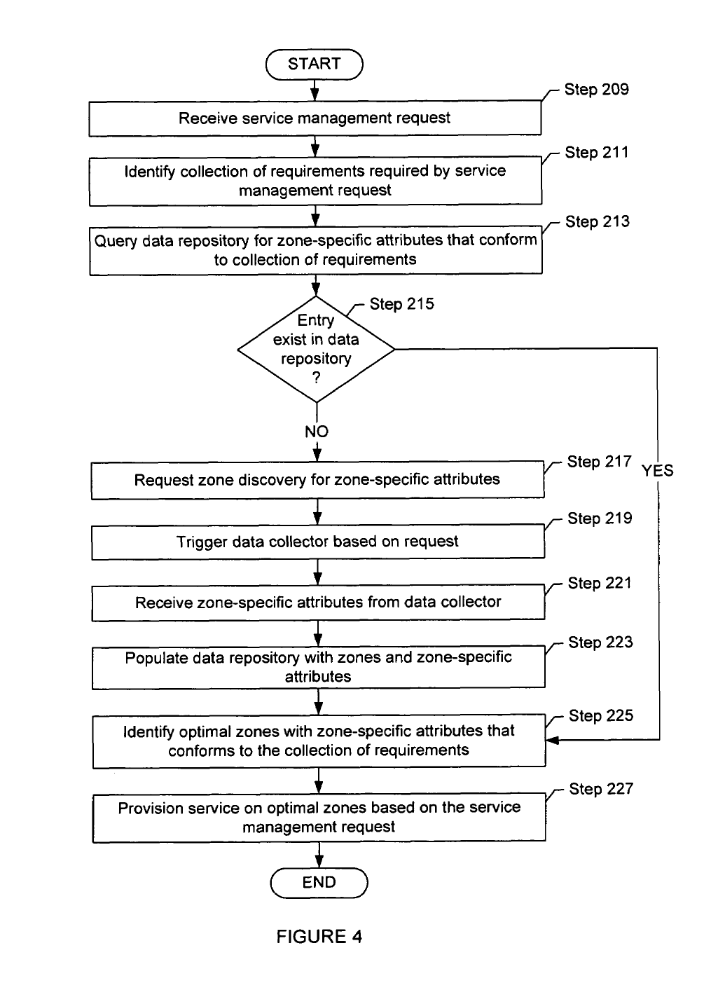

If the collated performance attributes indicate that the service requires additional resources, or if the client service manager anticipates that a service requires additional resources, then the client service manager may generate a service management request. FIG. 4 shows a flowchart of a method for processing a service management request to manage a in a zone environment in accordance with one or more embodiments of the invention. Initially, a service management request is received (Step 209). As discussed above, the service management request may be received because of anticipated use of the service, because the performance of the service does not satisfies a service level agreement, etc.

Accordingly, a collection of requirements that are required by the service management request are identified (Step 211). The collection of requirements may correspond to a service level agreement. In such scenario, the collection of requirements may indicate the number and type of service requests that should be processed in a particular amount of time, the application environment, the resources required by the service, etc. Typically, the service management request is received by the performance manager.

After receiving the service management request and identifying the collection of requirements, the data repository is queried for zone-specific attributes that conform to the collection of requirements (Step 213). Specifically, the performance manager requests that the data repository submit the zones that have zone performance attributes corresponding to the collection of requirements. Querying the data repository may be performed using any number of techniques well known in the art.

Thus, a determination is made whether an entry exists in the data repository that conforms to the collection of requirements (Step 215). At this stage, in accordance with one or more embodiments of the invention, the data repository may either return a list of zones that conform to the collection of requirements or return an empty list.

If an entry does not exist, then zone discovery for zone-specific attributes is requested (Step 217). At this stage, the performance manager may request zone discovery from the discovery manager. In response to the request for zone discovery, the discovery manager may trigger one or more data collectors based on the request (Step 219). In one or more embodiments of the invention, the data collector triggers both global zone data collectors to obtain information about the resources dedicated to a particular zone and non-global zone data collector to obtain information about the resources that are unused and dedicated to a particular zone.

Based on the triggering of the data collectors, zone-specific attributes are received from the data collector (Step 221). Specifically, the data collector may send zone-specific attributes that are collected over a period of time. Receiving the zone-specific attributes may be performed using techniques well known in the art.

After receiving the zone-specific attributes, the data repository is populated with zones and zone-specific attributes (Step 221). In particular, the newly received zone-specific attributes are stored in the data repository with the zone identifiers in accordance with one or more embodiments of the invention. Storing the zone-specific attributes may include overwriting any existing zone-specific attributes or archiving old zone-specific attributes to maintain a historical perspective.

Once the data repository is populated, or if an entry exists in the data repository, then the optimal zones that have zone-specific attributes that conform to the collection of requirements are identified (Step 223). Identifying the optimal zones may correspond to identifying the list of zones that have the zone-specific performance attributes that conform to the collection of requirements. Once the list is identified, then the optimal zones correspond to a subset of the list that would optimally execute the zone.

For example, suppose the collection of requirements included a requirement for 20% of any zone's resource usage. In the example, currently zone one has 50% resource usage available, zone two had 15% resource usage available, and zone three has 95% resource usage available. In such scenario, the list of zones that conform to the collection of requirements may include zone one and zone three. However, zone one may be more optimal than zone three because zone three has resources available for any later service management request for a different service that requires more than 50% resource usage. This comparison is done with the condition that the shortest path to the target virtual environment is used in conjunction with a general workload or specific performance metrics.

Those skilled in the art will appreciate that multiple parameters that render a particular zone optimal may exist. Further, the parameters for rendering a zone optimal may be implementation and/or system specific.

After the optimal zones are identified, then the service is provisioned on the optimal zones based on the service management request (Step 227). Specifically, the service management request is used to identify how the service is to be provisioned on the zones. Next, the service is provisioned in the identified optimal zones.

As shown in FIG. 3 and FIG. 4, the client service manager does not need to know any information about the particular hardware or the zones. Moreover, the client service manager may even be unaware of which zones contain which particular service managers executing on the zones.

In the following example, consider the scenario in which a client is a stock company that provides stock quotes using stock quote web service. The service level agreement for the client states that the stock quote web service should process one hundred stock quote requests per minute with each request processed in five seconds. In order to ensure that one hundred requests are processed each minute, data collectors are embedded in the stock quote service. Additional data collectors may also submit occasional requests to the stock quote service.

In the example, consider the scenario in which the data collectors identify that only fifty requests are processed each minute and each request is processed in five seconds. Accordingly, a performance manager may calculate that the stock quote service should be provisioned on twice as many zones. Accordingly, the performance manager queries the data repository for zones on a web server that conform to the requirements of the stock quote service. From the list of zones that are returned from the data repository, the optimal zones are identified and the stock quote web service is provisioned on the zones.

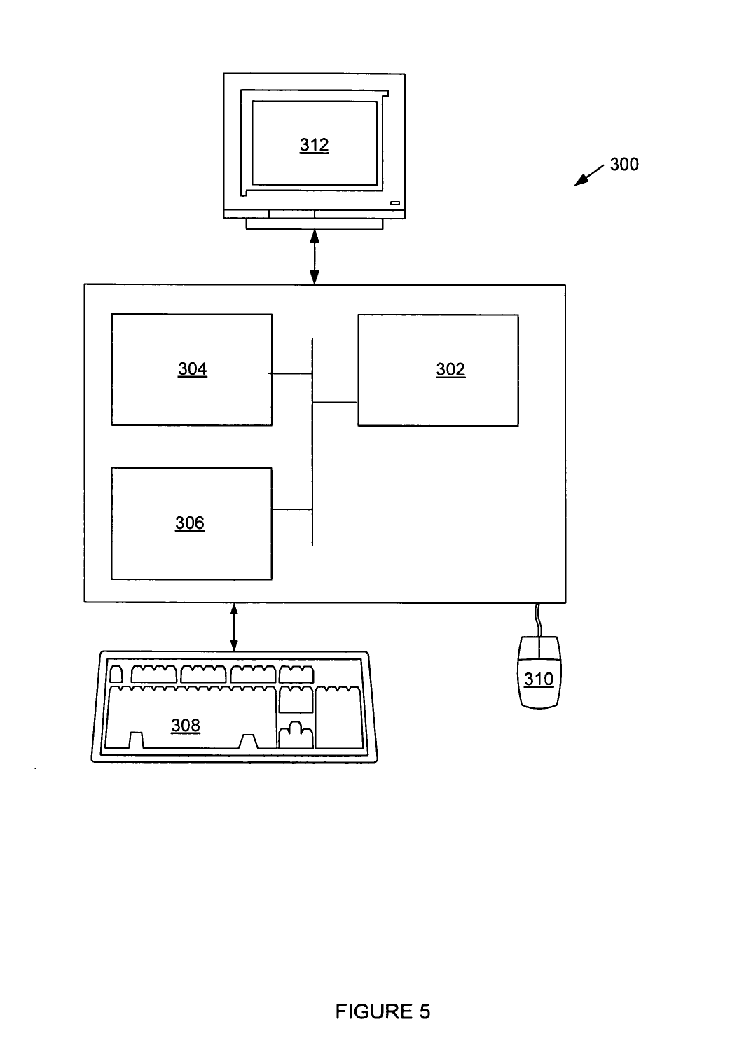

The invention, as described herein, may be implemented on virtually any type of computer regardless of the platform being used. For example, as shown in FIG. 5, a computer system (300) includes a processor (302), associated memory (304), a storage device (306), and numerous other elements and functionalities typical of today's computers (not shown). The computer (300) may also include input means, such as a keyboard (308) and a mouse (310), and output means, such as a monitor (312). The computer system (300) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (300) may be located at a remote location and connected to the other elements over a network. Further, the invention may be implemented on a distributed system having a plurality of nodes, where each portion of the invention (e.g., client service manager, data repository, global zone, non-global zones, discovery service manager, etc.) may be located on one or more different nodes within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a mechanism for identifying zones through the attributes of the zones. Specifically, embodiments of the invention provide a mechanism whereby client service managers are not required to know how the service that is being managed is executing in the zone environment. More specifically, the client service manager may be agnostic to the particular configuration of the zone architecture and the provisioning of the service within the zone architecture.

Thus, services may span multiple zones and the zones can span multiple hosts while simultaneously maintaining a simplified management environment for the client. Thus, one or more embodiments of the invention provide a mechanism for a simple interface to manage a service in a zone environment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing a service executing in a zone environment comprising:
receiving a service management request;
identifying a collection of requirements required by the service management request;
triggering a data collector to collect zone-specific performance attributes from a plurality of zones in the zone environment;
identifying at least one zone in the plurality of zones that has zone-specific performance attributes conforming to the collection of requirements; and
provisioning the service on the at least one zone based on the service management request.

2. The method of claim 1, further comprising:
receiving service-specific performance attributes for the at least one zone of the zone environment;
collating the service-specific performance attributes according to the service to obtain collated performance attributes; and
transmitting the collated performance attributes to a service manager, wherein the service manager manages the service using the performance attributes.

3. The method of claim 2, wherein the service-specific performance attributes comprise at least one selected from the group consisting of a response time indicator and a throughput indicator.

4. The method of claim 1, wherein the zone-specific performance attributes comprises at least one selected from the group consisting of a processor usage percentage, a memory usage percentage, a disk usage percentage, and a network usage percentage.

5. The method of claim 1, wherein the data collector is at least one probe.

6. The method of claim 1, wherein the data collector uses remote management application technology.

7. The method of claim 1, wherein the plurality of zones execute on a plurality of hosts.

8. The method of claim 1, further comprising:
populating a data repository with the zone-specific performance attributes.

9. A system for managing a service executing in a zone environment comprising:
a data collector configured to:
collect zone-specific performance attributes from a plurality of zones with the zone environment; and
a performance manager configured to:
receive a service management request;
identify a collection of requirements required by the service management request;
identify at least one zone in the plurality of zones that has zone-specific performance attributes conforming to the collection of requirements; and
provision the service on the at least one zone based on the service management request.

10. The system of claim 9, wherein the performance manager is further configured to:
receive service-specific performance attributes for the at least one zone of the zone environment;
collate the service-specific performance attributes according to the service to obtain collated performance attributes; and
transmit the collated performance attributes to a service manager, wherein the service manager manages the service using the performance attributes.

11. The system of claim 10, wherein the service-specific performance attributes comprise at least one selected from the group consisting of a response time indicator and a throughput indicator.

12. The system of claim 9, wherein the zone-specific performance attributes comprises at least one selected from the group consisting of a processor usage percentage, a memory usage percentage, a disk usage percentage, and a network usage percentage.

13. The system of claim 9, wherein the data collector is at least one probe.

14. The system of claim 9, wherein the data collector uses remote system invocation.

15. The system of claim 9, wherein the plurality of zones execute on a plurality of hosts.

16. The system of claim 9, further comprising:
populating a data repository with the zone-specific performance attributes.

17. A computer usable medium comprising computer readable program code embodied therein for causing a computer system to:
receive a service management request;
identify a collection of requirements required by the service management request;
trigger a data collector to collect zone-specific performance attributes from a plurality of zones;
identify at least one zone in the plurality of zones that has zone-specific performance attributes conforming to the collection of requirements; and
provision a service on the at least one zone based on the service management request.

18. The computer usable medium of claim 17, further comprising:
receive service-specific performance attributes for the at least one zone of the zone environment;
collate the service-specific performance attributes according to the service to obtain collated performance attributes; and
transmit the collated performance attributes to a service manager, wherein the service manager manages the service using the performance attributes.

19. The computer usable medium of claim 18, wherein the service-specific performance attributes comprise at least one selected from the group consisting of a response time indicator and a throughput indicator.

20. The computer usable medium of claim 17, wherein the zone-specific performance attributes comprises at least one selected from the group consisting of a processor usage percentage, a memory usage percentage, a disk usage percentage, and a network usage percentage.
